(19) United States
(12) Patent Application Publication
(10) Pub. No.: US 2026/0233190 A1
(43) Pub. Date: Aug. 13, 2026

(54) APPARATUS FOR PRODUCTION OF AMMONIUM NITRATE FROM NITRIC ACID AND AMMONIA

(71) Applicants: thyssenkrupp Uhde GmbH, Dortmund (DE); thyssenkrupp AG, Essen (DE)

(72) Inventors: Max Eliot GORGES, Dortmund (DE); Christiane POTTHOFF, Dortmund (DE)

(73) Assignees: thyssenkrupp Uhde GmbH, Dortmund (DE); thyssenkrupp AG, Essen (DE)

(21) Appl. No.: 19/155,854

(22) PCT Filed: Feb. 16, 2024
(86) PCT No.: PCT/EP2024/054037

§ 371 Date: Aug. 12, 2025

(30) Foreign Application Priority Data
Feb. 16, 2023 (DE) 10 2023 103 854.0
Feb. 16, 2023 (LU) LU 103073

(51) Int. Cl. B01J 19/24; B01J 4/00; B01J 12/00; C01C 1/18

(52) U.S. Cl. CPC B01J 19/244; B01J 4/001; B01J 12/00; B01J 19/2405; B01J 19/2435; C01C 1/185; B01J 2204/002

(57) ABSTRACT

An apparatus for production of ammonium nitrate from nitric acid and ammonia comprises a recirculation circuit, wherein a neutralization reactor is arranged in said recirculation circuit, wherein said neutralization reactor has at least a first region and a second region, wherein the first region is arranged fluidically in the recirculation circuit upstream of the second region, wherein the first region has at least one nitric acid supply apparatus, wherein the second region is a shell-and-tube reactor, wherein the tubes of the shell-and-tube reactor are designed for supplying ammonia, wherein the first region includes at least a first perforated plate, wherein the first perforated plate is arranged perpendicular to the direction of flow, wherein said first perforated plate is arranged in the direction of flow upstream of the nitric acid supply apparatus.

The invention relates to an apparatus for production of ammonium nitrate from nitric acid and ammonia, wherein a recirculation circuit is operated, that is to say a flow of ammonium nitrate is recirculated in a circuit, as a result of which local overheating in the strongly exothermic reaction between the nitric acid and ammonia is avoided.

In the reaction between nitric acid and ammonia two challenges arise. Firstly, the heat of reaction must be dissipated in order to avoid local overheating. This can be addressed for example by a recirculation circuit in which the circulated volume of ammonium nitrate is available to absorb the heat; a system with a recirculation circuit has been described for example by Axel Eben and Paul Kaupas in “Ammonium nitrate production and operational experience” (Nitrogen & Methanol No. 235 (1998), p. 25 ff). The ratio between reactants supplied to ammonium nitrate in circulation is normally between 1:5 to 1:100.

Secondly, the reactants are corrosive. Particularly the nitric acid, which is normally added first, results in corrosion damage, which in turn necessitates regular maintenance and replacement of parts.

A reactor for producing an ammonium nitrate solution is known from AU 654632 B.

The object of the invention is to reduce the extent of corrosion in the interior of the apparatus between the introduction of nitric acid and the—as complete as possible—reaction with ammonia.

This object is achieved by the apparatus having the features specified in claim 1. Advantageous developments are apparent from the dependent claims, from the description that follows, and from the drawing.

The apparatus according to the invention is used for production of ammonium nitrate from nitric acid and ammonia. The apparatus comprises a recirculation circuit. A large part of the product will thus be in circulation. As a result, a greater mass is available at the site of the reaction between the nitric acid and ammonia, with the result that the evolved heat of reaction is swiftly dispersed more strongly, thereby making it possible to reliably avoid temperature spikes. Arranged in the recirculation circuit is a neutralization reactor. In the neutralization reactor, the nitric acid and the ammonia are supplied so as to react with one another and form ammonium nitrate. The neutralization reactor comprises at least a first region and a second region. The first region is arranged fluidically in the recirculation circuit upstream of the second region. The first region has at least one nitric acid supply apparatus. The second region is a shell-and-tube reactor. The tubes of the shell-and-tube reactor are designed for supplying ammonia.

According to the invention, the first region includes at least a first perforated plate. The first perforated plate is arranged perpendicular to the direction of flow. The first perforated plate is arranged in the direction of flow upstream of the nitric acid supply apparatus. The key point is thus that the perforated plate is arranged upstream of the nitric acid supply apparatus, i.e. is not exposed to the nitric acid and accordingly not corroded. The strong turbulences at the perforated plate do however achieve very good and rapid mixing of the nitric acid in the ammonium nitrate. This makes it possible to dispense with flow-forming internals downstream of the nitric acid supply apparatus that, as a result of the arrangement, are heavily exposed to the still only slightly diluted nitric acid and therefore corrode easily.

In a further embodiment of the invention, the first perforated plate has a multitude of first holes. A first number of first holes is arranged adjacently to the wall of the first region. In addition, further holes may be arranged in the inner region (between the holes adjacent to the wall). The nitric acid supply apparatus has at least the first number of supply openings. Preferably, the nitric acid supply apparatus has exactly the first number of supply openings. This means that each hole and thus each turbulence generated by the hole is assigned to exactly one nitric acid supply apparatus. The nitric acid is as a result injected into a particularly turbulent region, thereby achieving particularly rapid mixing and thus dilution. Alternatively, it is possible for two nitric acid supply apparatuses, for example, to be assigned to each hole.

In a further embodiment of the invention, the first region has an axis of symmetry. In the case of a tube, the central axis is the axis of symmetry. Similarly, this also applies for example to a blunt-ended cone or to a body that is polygonal in cross section. The supply openings are either arranged perpendicular to the axis of symmetry or are arranged at an angle of not more than ±20° in the plane that is perpendicular to the axis of symmetry, deviating from the perpendicular on the axis of symmetry, and at an angle of not more than ±45° in the plane through which the axis of symmetry runs, deviating from the perpendicular on the axis of symmetry. It is thus particularly preferable that the supply opening, the turbulent flow that is generated by a hole, and the axis of symmetry are in a line. Alternatively, a deviation in the plane can be employed in order to achieve an additional rotation of the ammonium nitrate flow.

In a further embodiment of the invention, all supply openings have the same angle in the plane that is perpendicular to the axis of symmetry, deviating from the perpendicular on the axis of symmetry. This allows a directed vortex flow to be generated.

In a further embodiment of the invention, the supply openings are arranged such that the nitric acid supplied from each individual supply opening is introduced into exactly one turbulence generated by a hole in the first perforated plate adjacent to the wall of the first region.

In a further embodiment of the invention, the supply openings are made of polytetrafluoroethylene. Preferably, the supply openings are in the form of a polytetrafluoroethylene sleeve wedged into a flange. This arrangement, and the easy interchangeability of the sleeve, also gives rise to a distance in space from the hot container wall such that hot nitric acid does not come into contact with the metal wall directly.

In a further embodiment of the invention, the distance between the first perforated plate and the supply openings is less than 10% of the length of the zone of increased turbulence generated by the first perforated plate. Although it is preferable that the entire flow within the neutralization reactor is turbulent, the first perforated plate gives rise to a region with increased turbulent flow, wherein the Reynolds number is preferably at least 50% higher than the Reynolds number averaged over the entire cross section of the neutralization reactor at this point.

In a further embodiment of the invention, the distance between the first perforated plate and the supply openings is 0.08 times to 0.3 times the diameter of the first perforated plate.

In a further embodiment of the invention, the nitric acid flow coming from the supply opening is directed directly at the turbulence.

In a further embodiment of the invention, the first region includes at least a second perforated plate. The second perforated plate is arranged perpendicular to the direction of flow. The second perforated plate is arranged in the direction of flow between the nitric acid supply apparatus and the second region and thus the shell-and-tube reactor. The second perforated plate, after a first mixing through the first perforated plate, achieves further turbulences that result in further mixing, thereby achieving a homogenization in the neutralization that follows. The first mixing achieved at the first perforated plate is however already sufficient for the local nitric acid concentration to be reduced to such an extent that corrosion at the second perforated plate is limited.

In a further embodiment of the invention, the first region between the nitric acid supply apparatus and the end facing the second region has a length l. The second perforated plate is at a distance of at least 0.45 l from the nitric acid supply apparatus in the direction of flow. In addition, the second perforated plate is at a distance of at most 0.85 l from the nitric acid supply apparatus in the direction of flow. The second perforated plate is accordingly arranged in the middle part. This means that a sufficiently large proportion is available for the first mixing, with the result that the dilution of the nitric acid in the first part will have taken place to such an extent that corrosion can be largely avoided.

In a further embodiment of the invention, the first perforated plate has a first total number of holes. The second perforated plate has a second total number of holes. The second total number is greater than the first total number.

In a further embodiment of the invention, no internals are arranged between the supply openings and the second perforated plate. In this region in particular, local differences in the nitric acid concentration can be expected and therefore increased corrosion can occur as a result of locally higher concentrations.

In a further embodiment of the invention, the first region is conical. The first region has its greatest diameter where it adjoins the second region. Preferably, the first region is conical with an angle of 5° to 10°. This shallow angle prevents the flow from coming away from the wall and at the same time allows it to widen. The angle mentioned here is the angle between the wall and the axis of the neutralization reactor. The actual opening angle is thus twice as large, since this angle from 5° to 10° is to on both sides. The opening angle is thus between 10° and 20°.

In a further embodiment of the invention, the first perforated plate has holes with a shape selected from the group comprising circle, ellipse, oval, pointed oval, triangle, square, pentagon, hexagon, rectangle. Particularly preferably, the holes of the first perforated plate all have the same shape.

Particularly preferably, the first perforated plate has holes with a triangular shape. This is preferred, since the injection of the nitric acid by the nitric acid supply apparatus is often conical in shape, and as a result an optimal match is achieved between the turbulence generated by the first perforated plate and the injected nitric acid, thereby achieving particularly rapid and efficient mixing.

In a further embodiment of the invention, the second perforated plate has holes with a shape selected from the group comprising circle, ellipse, oval, pointed oval, square, pentagon, hexagon, rectangle. Particularly preferably, the holes of the second perforated plate all have the same shape.

By way of example and preferably, the holes of the first perforated plate and the holes of the second perforated plate have the same shape.

Alternatively, the holes of the first perforated plate have a triangular shape and the holes of the second perforated plate have a round shape. This can be advantageous, since the function of the turbulent regions generated by the first perforated plate is different from that of the second perforated plate. The function of the first perforated plate is to generate turbulences for the fastest-possible mixing of the injected nitric acid. The function of the second perforated plate is however primarily that of homogenization.

It is therefore preferable that the distribution of the holes in the first perforated plate is designed for optimal mixing of the injected nitric acid and thus configured locally and geometrically for the nitric acid supply apparatus.

It is preferable that the distribution of the holes of the second perforated plate is evenly distributed over the second perforated plate. For example, the holes of the second perforated plate may be arranged hexagonally.

In a further embodiment of the invention, the tubes of the shell-and-tube reactor are made of titanium. In addition, the tubes have holes of from 1 mm to 5 mm for the supply of ammonia. In order to prevent penetration of the tubes by ammonium nitrate, the ammonia surrounding the tubes is set to an overpressure of from 0.2 bar to 2 bar, preferably 0.2 bar to 1.2 bar, further preferably 0.5 bar to 1.2 bar, relative to the pressure of the ammonium nitrate in the tubes.

In a further embodiment of the invention, the neutralization reactor has a third region. The third region is arranged fluidically downstream of the second region. The third region includes a static mixer.

The apparatus of the invention is elucidated more particularly hereinbelow with reference to an exemplary embodiment shown in the drawing.

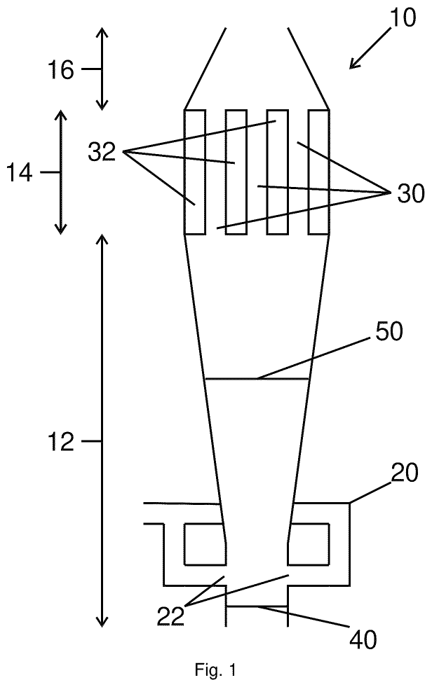

FIG. 1: Cross section

FIG. 1 shows the schematic cross section of part of an exemplary apparatus according to the invention, more precisely of the neutralization reactor 10 of the apparatus. The neutralization reactor 10 has three regions 12, 14, 16, a first region 12 located in the direction of flow at the start, a second region 14 in the middle executed in the form of a shell-and-tube reactor, and a third region 16. In the illustration below, a first perforated plate 40 is arranged in the flow as the first element. The first perforated plate has for example seven hexagonally arranged holes, i.e. six holes adjacent to the wall and a centrally located hole in the middle. When the ammonium nitrate flows through the holes, a region of turbulent flow develops downstream of each hole. Arranged just downstream of the first perforated plate 40 is the nitric acid supply apparatus 20, which has six (two visible in cross section) supply openings 22. Each of the supply openings 22 is directed onto one of the turbulent regions generated by the holes in the first perforated plate 40, with the result that the nitric acid is introduced into a region of flow that ensures very rapid dilution. The first region 12 has a length l between the supply openings 22 and the end facing the second region 14. In the example shown, a second perforated plate 50 is arranged at a distance of about 0.55 l from the supply openings 22 and about 0.45 l from the end of the first region 12 facing the second region 14. The first region 12 expands conically, for example at an angle of 10°. As a result, the diameter of the second perforated plate 50 shown here is greater (opening angle thus 20°) than that of the first perforated plate 40. For example, the second perforated plate has nineteen hexagonally arranged holes-one centrally in the middle, six in a ring surrounding the middle, and twelve in an outer ring adjacent to the wall. The second perforated plate 50 thus ensures further turbulences and thus even better mixing and at the same time homogeneity. Having a sufficient distance between the supply openings 22 and the second perforated plate 50 ensures that the homogenization brought about by the first perforated plate 40 and thus the dilution of the nitric acid before reaching the second perforated plate 50 is sufficiently high that no corrosion due to localized spots of higher nitric acid concentration occurs. The ammonium nitrate then flows in the second region 14 through the shell-and-tube reactor into the tubes 30. In the gas space 32 surrounding the tubes 30, ammonia is present with for example an overpressure of 1 bar relative to the ammonium nitrate. The ammonia penetrates into the ammonium nitrate through holes of for example 3 mm in diameter in the walls of the tubes 30 and reacts there with the nitric acid to form ammonium nitrate. After this, the neutralization reactor 10 in the example shown has another, third region 16 in which the cross section becomes reduced back to the original cross section (more particularly the tube cross section of the recirculation circuit). A mixer could be arranged in this third region.

### Reference Signs

10 Neutralization reactor
12 First region
14 Second region
16 Third region
20 Nitric acid supply apparatus
22 Supply opening
30 Tube
32 Gas space
40 First perforated plate
50 Second perforated plate

1-18. (canceled)

19. An apparatus for production of ammonium nitrate from nitric acid and ammonia, comprising:
a recirculation circuit;
wherein a neutralization reactor is arranged in said recirculation circuit;
wherein said neutralization reactor has at least a first region and a second region;
wherein the first region is arranged fluidically in the recirculation circuit upstream of the second region;
wherein the first region has at least one nitric acid supply apparatus;
wherein the second region is a shell-and-tube reactor;
wherein the tubes of the shell-and-tube reactor are designed for supplying ammonia;
wherein the first region includes at least a first perforated plate;
wherein the first perforated plate is arranged perpendicular to the direction of flow;
wherein said first perforated plate is arranged upstream of the nitric acid supply apparatus in the direction of flow.

20. The apparatus as claimed in claim 19, wherein the first perforated plate has a multitude of first holes, wherein a first number of first holes is arranged adjacently to the wall of the first region, wherein the nitric acid supply apparatus has at least the first number of supply openings.

21. The apparatus as claimed in claim 20, wherein the first region has an axis of symmetry, wherein the supply openings either are arranged perpendicular to the axis of symmetry or are arranged at an angle of not more than ±20° in the plane that is perpendicular to the axis of symmetry, deviating from the perpendicular on the axis of symmetry, and at an angle of not more than ±45° in the plane through which the axis of symmetry runs, deviating from the perpendicular on the axis of symmetry.

22. The apparatus as claimed in claim 21, wherein all supply openings have the same angle in the plane that is perpendicular to the axis of symmetry, deviating from the perpendicular on the axis of symmetry.

23. The apparatus as claimed in claim 20, wherein the supply openings are arranged such that the nitric acid supplied from each individual supply opening is introduced into exactly one turbulence generated by a hole in the first perforated plate adjacent to the wall of the first region.

24. The apparatus as claimed in claim 20, wherein the supply openings are made of polytetrafluoroethylene.

25. The apparatus as claimed in claim 19, wherein the distance between the first perforated plate and the supply openings is less than 10% of the length of the turbulent flow generated by the first perforated plate.

26. The apparatus as claimed in claim 19, wherein the distance between the first perforated plate and the supply openings is 0.08 times to 0.3 times the diameter of the first perforated plate.

27. The apparatus as claimed in claim 19, wherein the first region includes at least a second perforated plate, wherein the second perforated plate is arranged perpendicular to the direction of flow, wherein said second perforated plate is arranged in the direction of flow between the nitric acid supply apparatus and the second region and thus the shell-and-tube reactor.

28. The apparatus as claimed in claim 27, wherein the first region between the nitric acid supply apparatus and the end facing the second region has a length l, wherein the second perforated plate is at a distance of at least 0.45 l from the nitric acid supply apparatus in the direction of flow, wherein said second perforated plate is at a distance of at most 0.85 l from the nitric acid supply apparatus in the direction of flow.

29. The apparatus as claimed in claim 27, wherein the first perforated plate has a first total number of holes, wherein the second perforated plate has a second total number of holes, wherein the second total number is greater than the first total number.

30. The apparatus as claimed in claim 27, wherein no internals are arranged between the supply openings and the second perforated plate.

31. The apparatus as claimed in claim 19, wherein the first region is conical, wherein the first region has its greatest diameter where it adjoins the second region.

32. The apparatus as claimed in claim 31, wherein the first region is conical with an angle of 5° to 10°.

33. The apparatus as claimed in claim 19, wherein the first perforated plate has holes with a shape selected from the group comprising circle, ellipse, oval, pointed oval, triangle, square, pentagon, hexagon, rectangle.

34. The apparatus as claimed in claim 33, wherein the holes of the first perforated plate all have the same shape.

35. The apparatus as claimed in claim 19, wherein the tubes of the shell-and-tube reactor are made of titanium, wherein the tubes having holes of from 1 mm to 5 mm for the supply of ammonia.

36. The apparatus as claimed in claim 19, wherein the neutralization reactor has a third region, wherein the third region is arranged fluidically downstream of the second region, and wherein the third region includes a static mixer.
